(19) United States
(12) Patent Application Publication
(10) Pub. No.: US 2016/0041614 A1
(43) Pub. Date: Feb. 11, 2016

(54) SYSTEM AND METHOD OF INDUCING USER EYE BLINK

(71) Applicant: Samsung Display Co., Ltd., Yongin-City (KR)

(72) Inventors: Rang Kyun MOK, Seoul (KR); Jong In BAEK, Suwon-si (KR); Yi Joon AHN, Seoul (KR)

(21) Appl. No.: 14/572,344

(22) Filed: Dec. 16, 2014

(30) Foreign Application Priority Data
Aug. 6, 2014 (KR) 10-2014-0101218

(51) Int. Cl. G06F 3/01; G06F 3/00

(52) U.S. Cl. CPC G06F 3/013; G06F 3/005

(57) ABSTRACT

According to an exemplary embodiment, a blink device includes: a blink detector configured to detect a blink of a user from an image photographed by a camera; a period measurer configured to measure a time period between consecutive blinks of the user and determine whether the measured time period exceeds a reference time period; a real-time image capture unit configured to capture a real-time image of the user from the photographed image; and an image processor configured to perform the following if the measured time period exceeds the reference time period: generate from the real-time image a blink image for inducing the user to blink, delay the display of the blink image by a delay period from when the user's blink is detected, and display the blink image after the delaying.

### CROSS-REFERENCE TO RELATED APPLICATION

This application claims priority to and the benefit of Korean Patent Application No. 10-2014-0101218 filed in the Korean Intellectual Property Office on Aug. 6, 2014, the entire contents of which are incorporated herein by reference.

### BACKGROUND

(a) Field

Embodiments of the present system and method relate to a blink device of a display device and a blink inducing method. More particularly, the present system and method relate to a blink device for inducing a blink of a user using a display device, and a method of inducing thereof.

(b) Description of the Related Art

With the widespread use of mobile smart devices such as tablet PCs and smart phones, instances of users watching their smart devices for a long time are increasing. Particularly, when these users intensively watch the smart devices, they unwittingly blink less, thereby bringing about eye fatigues and failing of eyesight.

### SUMMARY

The present system and method provide a blink device of a display device for inducing a blink of a user using a display device and a method of inducing thereof.

An exemplary embodiment of the present system and method provides a blink device including: a blink detector configured to detect a blink of a user from an image photographed by a camera; a period measurer configured to measure a time period between consecutive blinks of the user, and determine whether the measured time period exceeds a reference time period; a real-time image capture unit configured to capture a real-time image of the user from the photographed image; and an image processor configured to perform the following if the measured time period exceeds the reference time period: generate from the real-time image a blink image for inducing the user to blink, delay the display of the blink image by a delay period from when the user's blink is detected, and display the blink image after the delaying.

The image processor may be further configured to generate an additional blink image for display in place of the blink image during the delay period.

The additional blink image may be an image of the user's face and generated from a photographed image of the user in which the user's eyes are opened, and the blink image may be an image of the user's face and generated from a photographed image of the user in which the user's eyes are closed.

The additional blink image may be an image of the user's eye portions and generated from a photographed image of the user in which the user's eyes are opened, and the second blink image may be an image of the user's eye portions and generated from a photographed image of the user in which the user's eyes are closed.

The blink image may have transparent properties.

The blink image may be an image of the user's face and generated from a photographed image of the user in which the user's eyes are opened.

The blink image may be an image of the user's face and generated from a photographed image of the user in which the user's eyes are closed.

The blink image may be an image of the user's eye portions and generated from a photographed image of the user in which the user's eyes are opened.

The blink image may be an image of the user's eye portions and generated from a photographed image of the user in which the user's eyes are closed.

The delay time may be less than the reference time period.

The blink device may further include a camera controller configured to control the driving of the camera, and provide the photographed image to the blink detector and the real-time image capture unit.

According to an embodiment of the present system and method, a method for inducing a blink, includes: detecting a blink of a user from an image photographed by a camera; measuring a time period between consecutive blinks of the user; comparing the measured time period between the user's blinks and a reference time period; and performing the following if results of the comparing indicate that the measured time period exceeds the reference time period: delaying the display of a blink image by a delay time period from when the user's blink is detected, and displaying the blink image after the delaying.

The method may further include capturing a real-time image from the photographed image, and generating the blink image from the real-time image.

The method may further include generating an additional blink image and displaying the additional blink image in place of the blink image during the delay period.

The additional blink image may be an image of the user's face and generated from a photographed image of the user in which the user's eyes are opened, and the second blink image may be an image of the user's face and generated from a photographed image of the user in which the user's eyes are closed.

The additional blink image may be an image of the user's eye portions and generated from a photographed image of the user in which the user's eyes are opened, and the second blink image may be an image of the user's eye portions and generated from a photographed image of the user in which the user's eyes are closed.

The blink image may be repeatedly displayed when the user's blink is detected.

The blink image may include at least one of an image of the user's face with his eyes opened, an image of the user's face with his eyes closed, an image of the opened eye portions of the user, and an image of the closed eye portions of the user.

The delay time period may be less than the reference time period.

Embodiments of the present system and method prevent eye fatigue and failure of eyesight by inducing a user of a mobile smart device, such as a tablet PC or a smart phone, to blink. Furthermore, by using the photographed face of the user to induce the user to blink, the user's repulsion is reduced.

### BRIEF DESCRIPTION OF THE DRAWINGS

FIG. 1 shows a block diagram of a blink device, according to an exemplary embodiment of the present system and method.

FIG. 2 shows a flowchart of a method for driving a blink device, according to an exemplary embodiment of the present system and method.

FIG. 3 shows a timing diagram of a method for inducing a user's blink, according to an exemplary embodiment of the present system and method.

FIG. 4 shows an example of a first blink image of FIG. 3, according to an exemplary embodiment of the present system and method.

FIG. 5 shows an example of a second blink image of FIG. 3, according to an exemplary embodiment of the present system and method.

FIG. 6 shows a method for inducing a user's blink by using a first blink image of FIG. 4 and a second blink image of FIG. 5, according to an exemplary embodiment of the present system and method.

FIG. 7 shows another example of a first blink image of FIG. 3, according to an exemplary embodiment of the present system and method.

FIG. 8 shows another example of a second blink image of FIG. 3, according to an exemplary embodiment of the present system and method.

FIG. 9 shows a method for inducing a user's blink by using a first blink image of FIG. 7 and a second blink image of FIG. 8, according to an exemplary embodiment of the present system and method.

FIG. 10 shows a flowchart of a method for driving a blink device, according to another exemplary embodiment of the present system and method.

FIG. 11 shows a timing diagram of a method for inducing a user's blink, according to another exemplary embodiment of the present system and method.

FIG. 12 shows a method for inducing a user's blink by using a blink image, according to an exemplary embodiment of the present system and method.

FIG. 13 shows a method for inducing a user's blink by using a blink image, according to another exemplary embodiment of the present system and method.

FIG. 14 shows a method for inducing a user's blink by using a blink image, according to the other exemplary embodiment of the present system and method.

FIG. 15 shows a method for inducing a user's blink by using a blink image, according to the other exemplary embodiment of the present system and method.

### DETAILED DESCRIPTION OF THE EMBODIMENTS

Certain exemplary embodiments of the present system and method are shown and described herein for the purpose of illustration. Those of ordinary skill in the art would realize that the described embodiments may be modified in various different ways without departing from the spirit or scope of the present system and method.

The same constituent elements across multiple embodiments are designated using the same reference numerals. A constituent element that has been described with reference to an embodiment may not be described with reference to other embodiments to avoid redundancy, even if the constituent element is included in other embodiments.

Throughout this specification and the claims that follow, when an element is described as being “coupled” to another element, the element may be “directly coupled” to the other element or “electrically coupled” to the other element through a third element. In addition, unless explicitly described to the contrary, the word “comprise” and variations such as “comprises” or “comprising” are understood to imply the inclusion of stated elements but not the exclusion of any other elements.

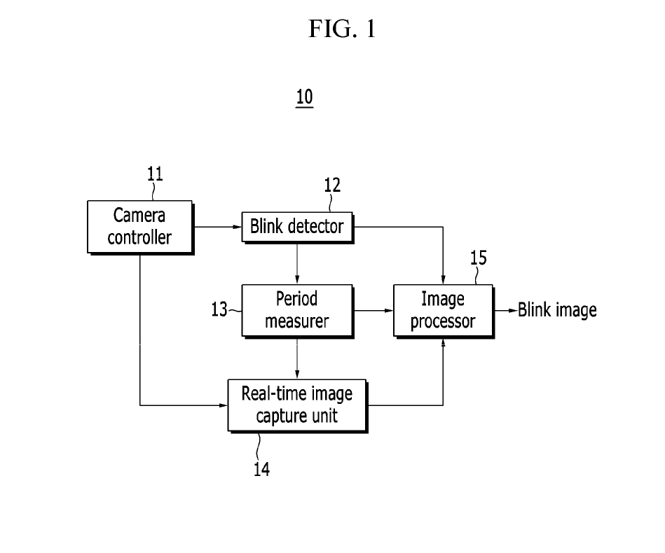

FIG. 1 shows a block diagram of a blink device, according to an exemplary embodiment of the present system and method. Referring to FIG. 1, the blink device 10 includes a camera controller 11, a blink detector 12, a period measurer 13, a real-time image capture unit 14, and an image processor 15.

The camera controller 11 controls the driving of a camera (not shown). The camera may be, for example, a front-type camera for photographing a user at a portable terminal or a computer. The camera controller 11 may control general camera functions such as autofocusing, enlargement and reduction, image stabilization, and photographing still images and/or motion pictures. The camera controller 11 transmits data corresponding to a photographed image to the blink detector 12 and the real-time image capture unit 14. The photographed image may be, for example, a motion picture acquired by photographing the user.

Based on the photographed image, the blink detector 12 determines whether the user blinked his/her eyes. The blink detector 12 may, for example, analyze the user's face using a face recognition algorithm and identify the user's eyes from the face. Thus, the blink detector 12 monitors the user's eyes to detect when the user's eyes blink.

According to an exemplary embodiment, the blink detector 12 may assume that pupils of the eyes of the user are circular and use a circle detection algorithm to detect a position of the pupil, thereby detecting eye portions of the user. In such case, the pupils are detected while the user's eyes are open but not detected while they are closed. In this manner, the blink detector 12 detects the user's blink by measuring a time during which the detection of the pupil of the user is stopped, that is, the pupil is no longer detected. The blink detector 12 transmits information including the time when the user's blink is detected to the period measurer 13 and the image processor 15.

The period measurer 13 measures the user's blink period based on the information received from the blink detector 12 that includes the time when the user's blink is detected. The period measurer 13 compares the user's blink period with a reference period. The reference period, for example, may be established with reference to a statistically significant number (e.g., average number of blinks within a time period). For example, if the average number of blinks is 15 to 20 per minute, the reference period may be set to be 3 to 4 seconds. The period measurer 13 may induce a user's blink when the user's blink period is greater than the reference period. Upon the determination to induce a user's blink, the period measurer 13 instructs the real-time image capture unit 14 to capture a real-time image and the image processor 15 to generate a blink image.

The real-time image capture unit 14 captures a real-time image from the photographed image transmitted by the camera controller 11. That is, the real-time image capture unit 14 stores the photographed image in real time to capture a real-time image. The real-time image capture unit 14 transmits the real-time image to the image processor 15.

Based on the real-time image transmitted from the real-time image capture unit 14, the image processor 15 generates a blink image for inducing a user to blink. The blink image may include a first blink image and a second blink image. According to an embodiment, the first blink image may be acquired by photographing the face of the user with his eyes opened, and the second blink image may be acquired by photographing the face of the user with his eyes closed. In another embodiment, the first blink image may be an image acquired by photographing only the opened eye portions of the user, and the second blink image may be an image acquired by photographing only the closed eye portions of the user.

The image processor 15 may generate the first blink image and the second blink image using information transmitted by the blink detector 12, including the time when the user's blink is detected. For example, the image processor 15 may generate the second blink image from a real-time image captured at a time when the user's blink is detected and the first blink image from a real-time image captured at a time when the user's blink is not detected. The image processor 15 may process the blink image to include the user's face portion or eye portions when generating the blink image from the real-time image. The image processor 15 may vary the transparency of the blink image when generating the blink image from the real-time image so that when the blink image is displayed to overlap another image, both images are visible to the user and a subliminal effect is induced.

The image processor 15 may delay the display of second blink image by a delay time from the time when the user's blink is detected. After the delay, the second blink image may be displayed while the first blink image is being displayed. That is, the image processor 15 may wait for a time period, equal to the delay time, after the user blinks and then display the second blink image through the display device. The image processor 15 may temporarily store the first blink image and the second blink image so as to delay the display of the second blink image. The delay time may be set to be less than the reference period. For example, if the reference period is 3 to 4 seconds, the delay time may be set to be 1 to 2 seconds.

The image processor 15 may generate a single blink image and display the same without distinguishing the blink image as a first blink image and a second blink image. The blink image may be acquired by photographing the user's appearance at any time. In this instance, the blink image may include at least one of an image acquired by photographing the face of the user with his eyes opened, an image acquired by photographing the face of the user with his eyes closed, an image acquired by photographing the opened eye portion of the user, and an image acquired by photographing the closed eye portion of the user.

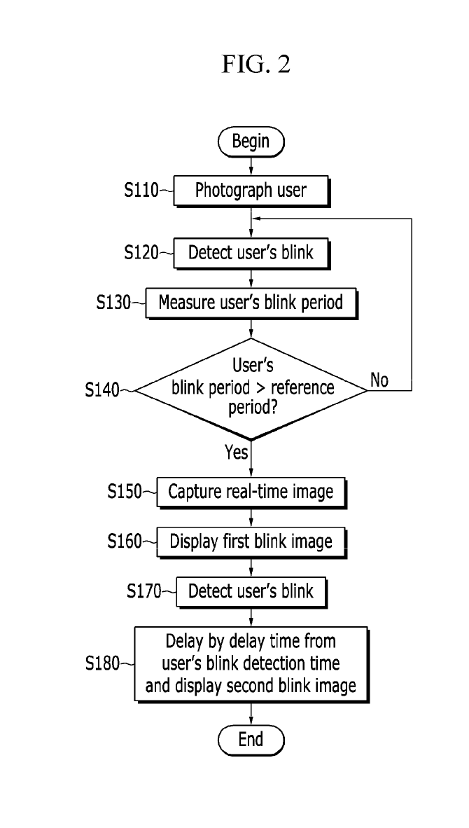

FIG. 2 shows a flowchart of a method for driving a blink device, according to an exemplary embodiment of the present system and method. Referring to FIG. 2, the camera controller 11 controls the camera to continually photograph the user (S110). That is, a series of photographed images, or a motion picture, may be acquired by photographing the user repeatedly. The photographed images are transmitted to the blink detector 12 and the real-time image capture unit 14.

The blink detector 12 detects the user's blink from one or more of the photographed images (S120). The blink detector 12, for example, recognizes the user's face from the photographed images by using a face recognition algorithm and detects the user's blink by monitoring the user's eye portion. Information including the time when the user's blink is detected is transmitted to the period measurer 13 and the image processor 15.

The period measurer 13 measures the user's blink period based on the information including the time when the user's blink is detected (S130). The user's blink period may be measured as a frame of time between two consecutive blinks.

The period measurer 13 compares the user's blink period and a reference period (S140). The reference period may be established with reference to a statistical significant value, such as an average number of blinks. For example, the reference period may be set to be 3 to 4 seconds. When the user's blink period is equal to or less than the reference period, the stages S120 to S140 are repeated.

When the user's blink period is greater than the reference period, the period measurer 13 determines to induce the user to blink, instructs the real-time image capture unit 14 to capture a real-time image (e.g., store the most recent photographed image), and instructs the image processor 15 to generate a blink image.

As instructed by the period measurer 13, the real-time image capture unit 14 captures the real-time image from the photographed images transmitted by the camera controller 11 (S150). The real-time image is transmitted to the image processor 15.

From the real-time image transmitted by the real-time image capture unit 14, the image processor 15 generates a first blink image and a second blink image for inducing a user's blink. The image processor 15 displays the first blink image (S160). The first blink image may be generated with a level of transparency so that when the first blink image is displayed to overlap with another image, both images are visible to the user. The first blink image may be consecutively displayed.

The blink detector 12 detects the user's blink from the photographed images (S170). The blink detector 12 transmits information including the time when the user's blink is detected to the image processor 15.

The image processor 15 delays the display of the second blink image by a delay time from the time when the user's blink is detected and then displays the second blink image (S180). The delay time may be set to be less than the reference period.

The blink device 10 may be installed as an integrated circuit (IC) chip in a display device such as a tablet PC or a smartphone. A method for driving the blink device 10 may be provided as an application program for supporting the display device. The application program may be recorded in a storage medium.

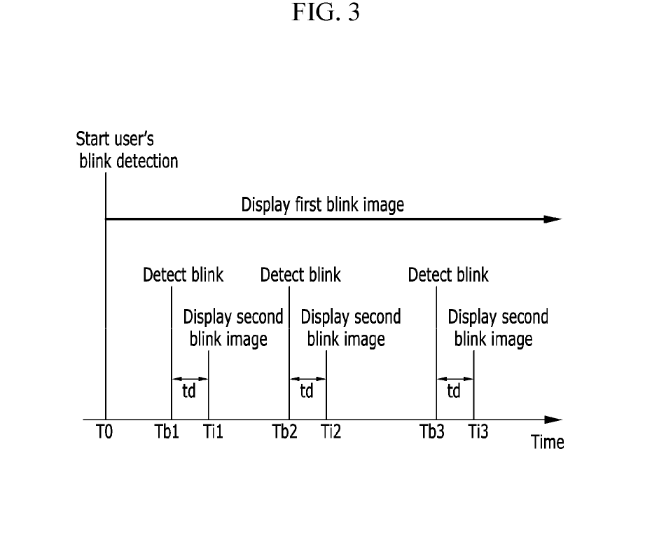

An example of a display device that induces a user to blink is described. FIG. 3 shows a timing diagram of a method for inducing a user's blink, according to an exemplary embodiment of the present system and method. Referring to FIG. 3, when a determination to induce the user's blink is formed, the first blink image and the second blink image are generated, and the user's blink detection for inducing the user to blink starts from the time T0.

The first blink image is continually displayed from the time T0. The first blink image may be a real-time image of the user that is continually updated by the camera controller, resulting in a motion picture. In another case, the first blink image may be a still image of the user that was photographed at a point in time. For example, the first blink image may be a still image of the user that was photographed at a time when the user opened his eyes.

When the user's blink is detected at the time Tb1 after the user's blink detection starts, the second blink image is displayed at the time Ti1 that is delayed from the time Tb1 by a predetermined delay time (Td). When the user's blink is detected at the time Tb2, the second blink image is displayed at the time Ti2 that is delayed from the time Tb2 by a predetermined delay time (Td). When the user's blink is detected at the time Tb3, the second blink image is displayed at the time Ti3 that is delayed from the time Tb3 by a predetermined delay time (Td). The second blink image may be an image of the user that was photographed at a point in time when the user closed his eyes.

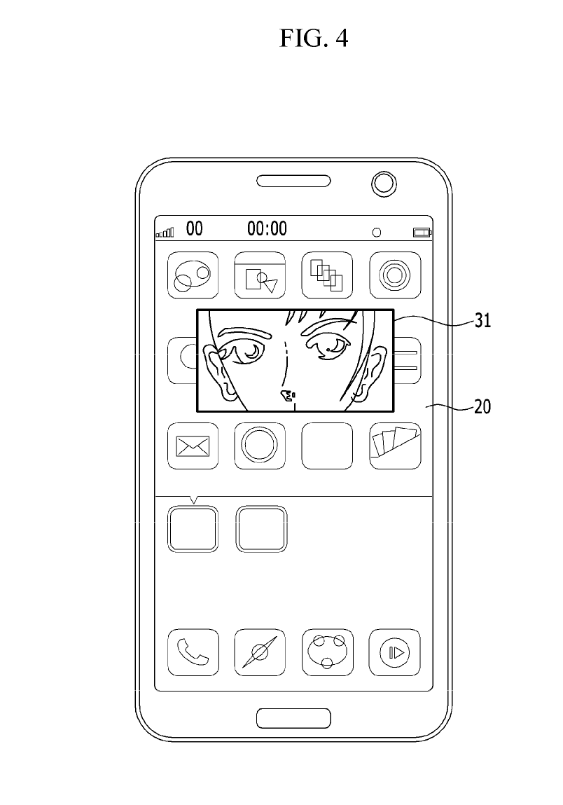

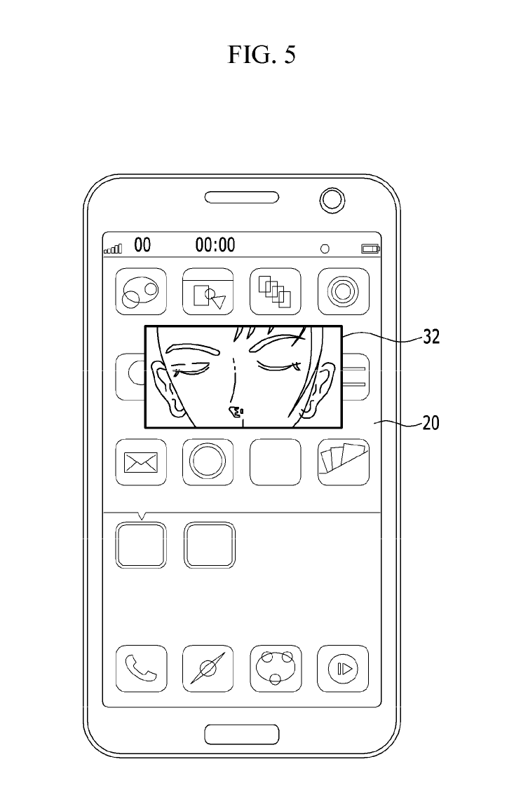

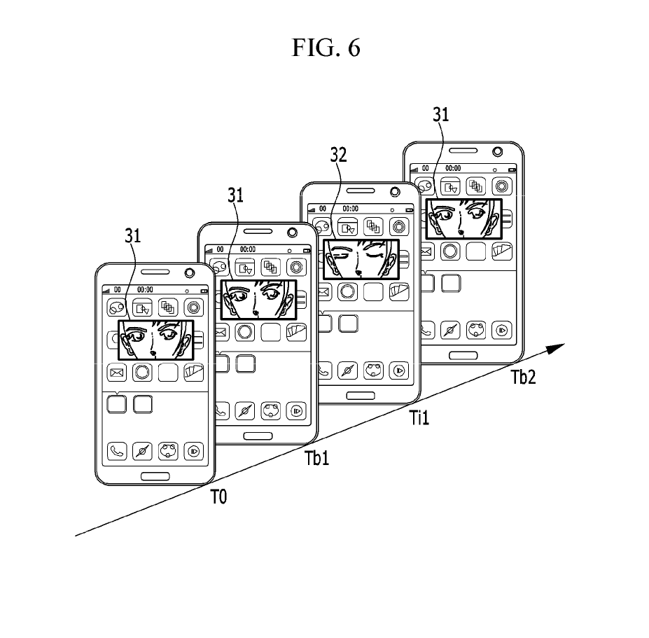

FIG. 4 shows an example of a first blink image of FIG. 3, according to an exemplary embodiment. FIG. 5 shows an example of a second blink image of FIG. 3, according to an exemplary embodiment. FIG. 6 shows a method for inducing a user's blink by using a first blink image of FIG. 4 and a second blink image of FIG. 5, according to an exemplary embodiment.

Referring to FIG. 4, an example for displaying a first blink image 31 in a region of a display area 20 of the display device is provided. The first blink image 31 represents an image acquired by photographing a face of the user with his eyes opened. Here, the first blink image 31 is shown to be opaque such that another image in the rear is not seen. However, the first blink image 31 may have transparent properties such when the first blink image 31 is displayed to overlap the rear image, both the first blink image 31 and the overlapping portion of the rear image are visible to the user.

Referring to FIG. 5, an example for displaying a second blink image 32 in a region of the display area 20 of the display device is provided. The second blink image 32 may be acquired by photographing the user's face with his eyes closed. Here, the second blink image 32 is shown to be opaque such that another image in the rear is not seen. However, the second blink image 32 may have transparent properties such that when the second blink image 32 is displayed to overlap the rear image, both the second blink image 32 and the overlapping portion of the rear image are visible to the user.

Referring to FIG. 6, a process for inducing the user to blink with the first blink image 31 of FIG. 4 and the second blink image 32 of FIG. 5 is provided. The first blink image 31 is continuously displayed from the time T0 when the user's blink detection starts, including at the time Tb1 when the user's blink is detected. The second blink image 32 is displayed at the time Ti1, which is delayed from the time Tb1 by a delay time (Td). The second blink image 32 may be displayed once and the first blink image 31 is automatically displayed. The first blink image 31 is displayed at the time Tb2 when the user's blink is detected.

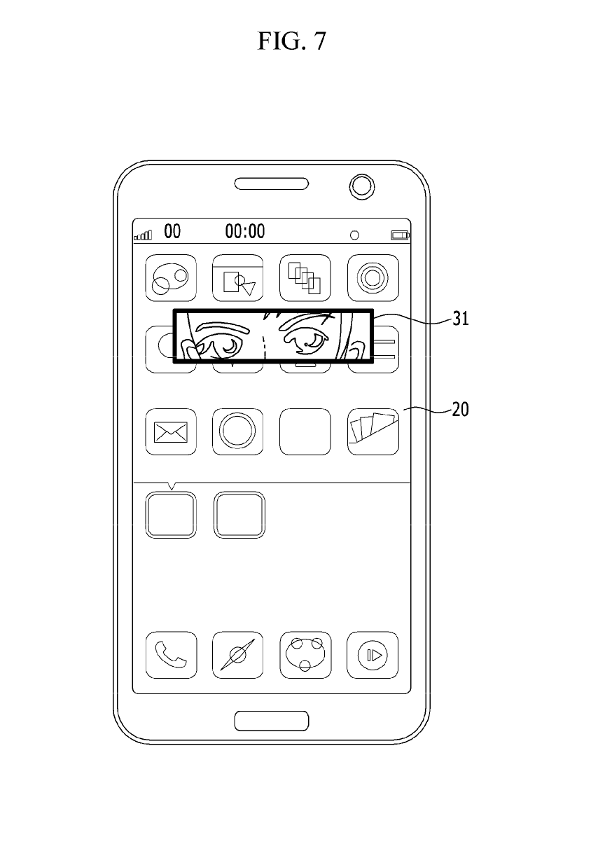

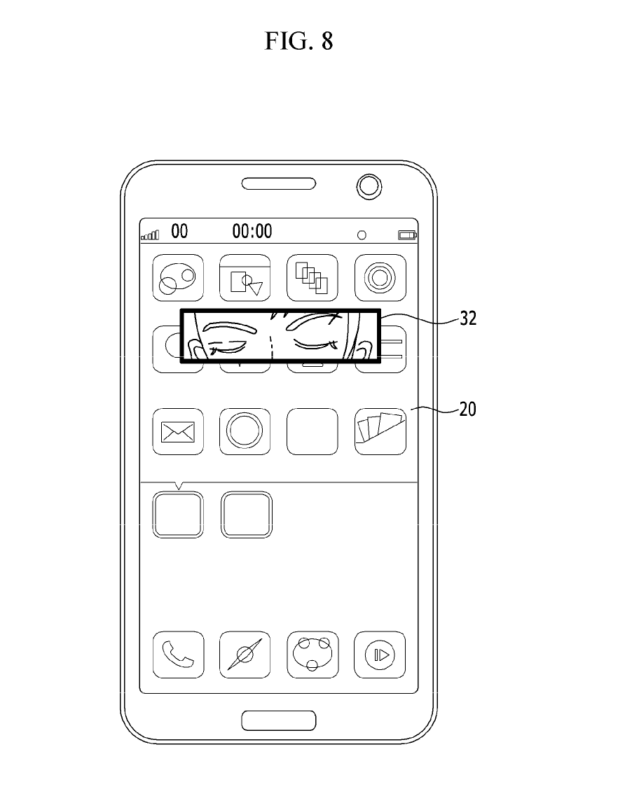

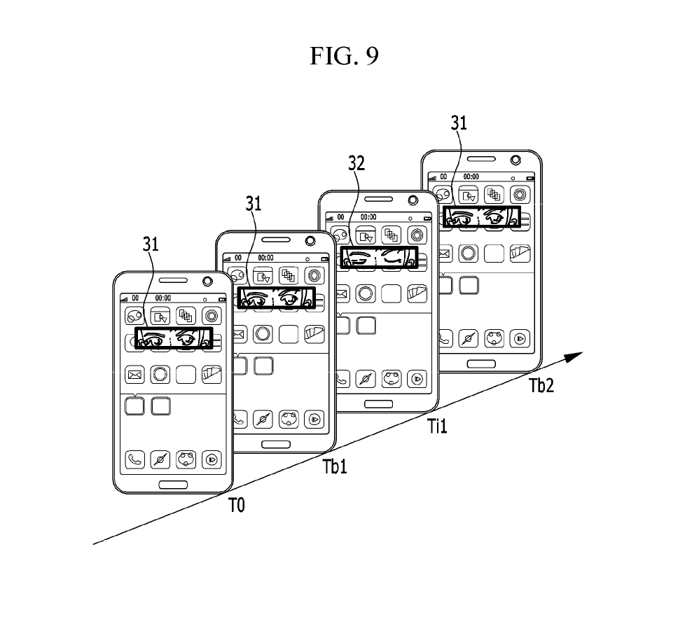

FIG. 7 shows another example of a first blink image of FIG. 3, according to an exemplary embodiment. FIG. 8 shows another example of a second blink image of FIG. 3, according to an exemplary embodiment. FIG. 9 shows a method for inducing a user's blink by using a first blink image of FIG. 7 and a second blink image of FIG. 8, according to an exemplary embodiment.

Referring to FIG. 7, an example for displaying a first blink image 31 in a region of the display area 20 of the display device is provided. The first blink image 31 may be acquired by photographing the opened eye portion of the user. Here, the first blink image 31 is shown to be opaque such that another image in the rear is not seen. However, the first blink image 31 may have transparent properties such that when the first blink image 31 is displayed to overlap the rear image, both the first blink image 31 and the overlapping portion of the rear image are visible to the user.

Referring to FIG. 8, an example for displaying a second blink image 32 in a region of the display area 20 of the display device is provided. The second blink image 32 may be acquired by photographing the closed eye portion of the user. Here, the second blink image 32 is shown to be opaque such that another image in the rear is not seen. However, the second blink image 32 may have transparent properties such that when the second blink image 32 is displayed to overlap the rear image, both the second blink image 32 and the overlapping portion of the rear image are visible to the user.

Referring to FIG. 9, a process for inducing the user to blink with the first blink image 31 of FIG. 7 and the second blink image 32 of FIG. 8 is provided. The first blink image 31 is displayed from the time T0 when the user's blink detection starts, including at the time Tb1 when the user's blink is detected. The second blink image 32 is displayed at the time Ti1, which is delayed from the time Tb1 by a delay time (Td). The first blink image 31 is displayed at the time Tb2 when the user's blink is detected.

As described above, when the user's blink is detected, the display of the second blink image 32 is delayed to induce the user's blink according to the user's blink period. Moreover, the user's own photographed image is used to reduce his repulsion for other's face images.

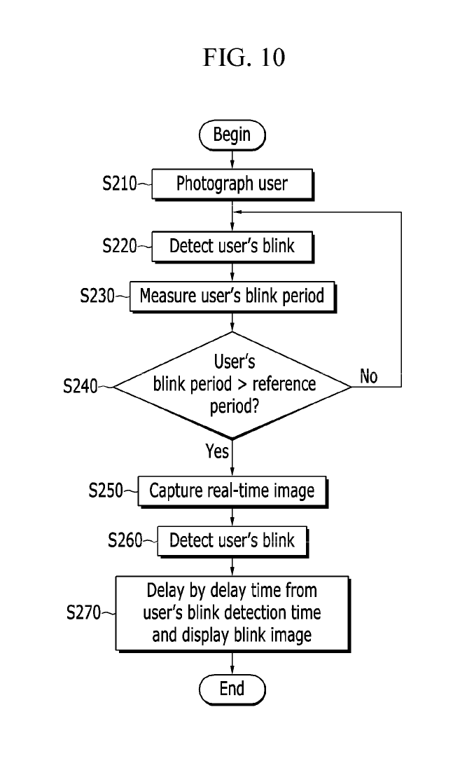

FIG. 10 shows a flowchart of a method for driving a blink device, according to another exemplary embodiment of the present system and method. Referring to FIG. 10, the camera controller 11 controls the camera to continually photograph the user (S210). The blink detector 12 detects the user's blink from one or more of the photographed images (S220). The period measurer 13 measures the user's blink period based on the information received from the blink detector 12, including the time when the user's blink is detected (S230).

The period measurer 13 compares the user's blink period and a reference period (S240). When the user's blink period is greater than the reference period, the period measurer 13 to induce the user to blink, instructs the real-time image capture unit 14 to capture a real-time image, and instructs the image processor 15 to generate a blink image.

As instructed by the period measurer 13, the real-time image capture unit 14 captures the real-time image from the photographed images transmitted by the camera controller 11 (S250). From the real-time image transmitted by the real-time image capture unit 14, the image processor 15 generates a blink image for inducing a user's blink. The blink image may include at least one of an image acquired by photographing the face of the user with his eyes opened, an image acquired by photographing the face of the user with his eyes closed, an image acquired by photographing the opened eye portion of the user, and an image acquired by photographing the closed eye portion of the user.

The blink detector 12 detects the user's blink from the photographed images (S260).

The image processor 15 delays the display of the blink image by a delay time from the time when the user's blink is detected and then displays the blink image (S270). The blink image for inducing the user's blink is not displayed unless the user's blink is detected. That is, when compared to the method for driving a blink device described with reference to FIG. 2, the difference is that the first blink image is not displayed. The remaining process is performed in a like manner.

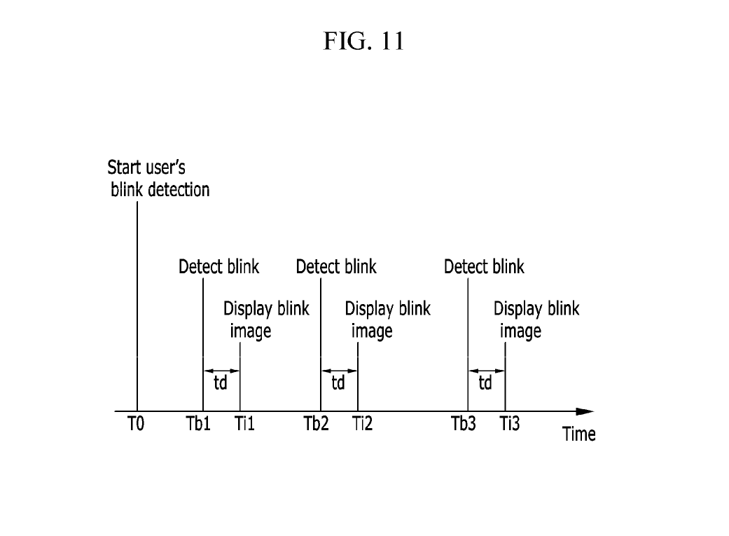

FIG. 11 shows a timing diagram of a method for inducing a user's blink, according to another exemplary embodiment of the present system and method.

Referring to FIG. 11, when the determination to induce the user's blink is formed, the blink image is generated, the user's blink detection for inducing the user's blink starts from the time TO. The blink image may include at least one of an image acquired by photographing the face of the user with his eyes opened, an image acquired by photographing the face of the user with his eyes closed, an image acquired by photographing the opened eye portion of the user, and an image acquired by photographing the closed eye portion of the user.

When the user's blink is detected at the time Tb1 after the user's blink detection starts, the blink image is displayed at the time Ti1 that is delayed from the time Tb1 by a predetermined delay time (Td). When the user's blink is detected at the time Tb2, the blink image is displayed at the time Ti2 that is delayed from the time Tb2 by a predetermined delay time (Td). When the user's blink is detected at the time Tb3, the blink image is displayed at the time Ti3 that is delayed from the time Tb2 by a predetermined delay time (Td).

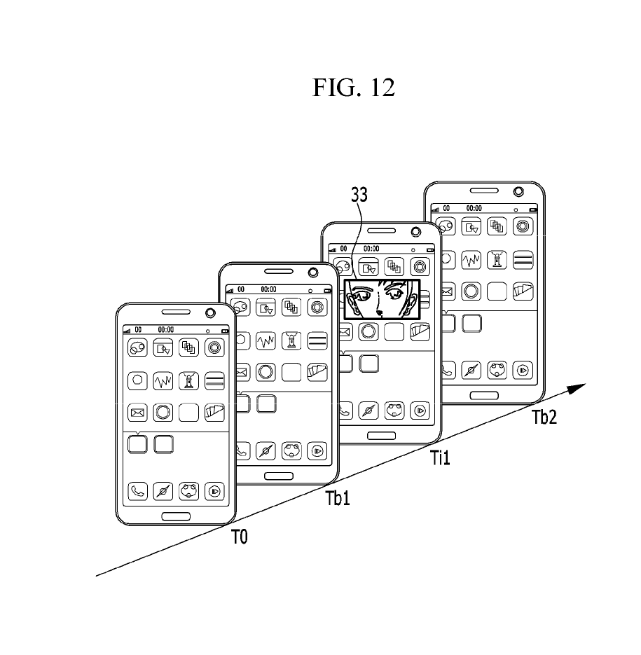

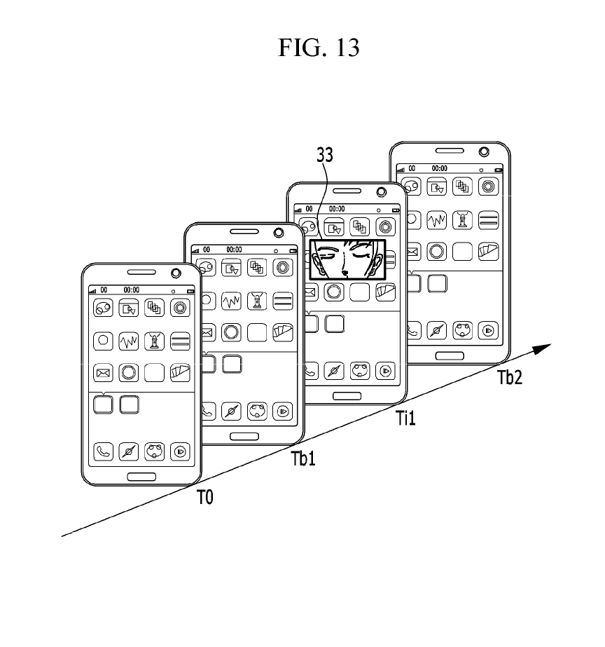

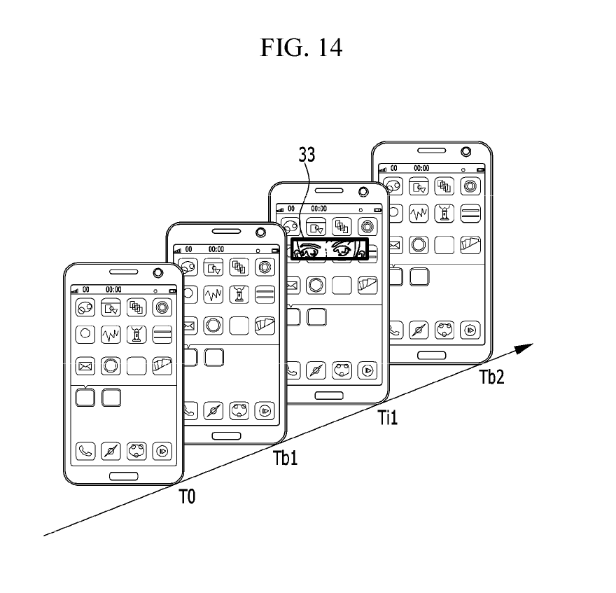

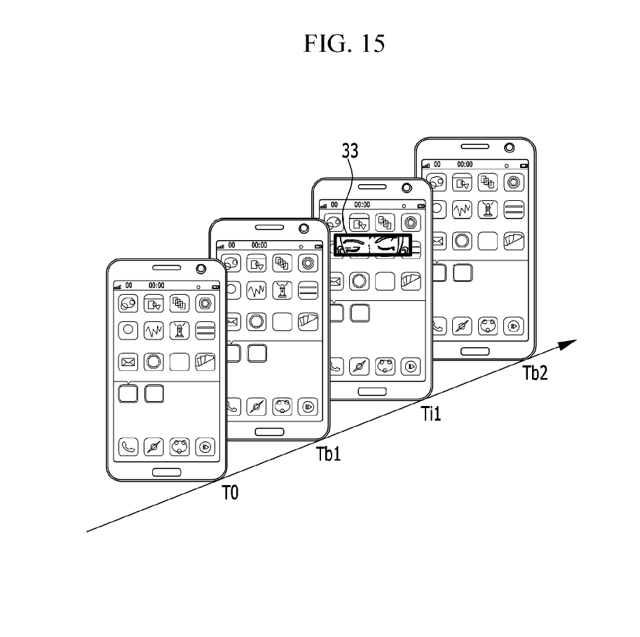

FIG. 12 shows a method for inducing a user's blink by using a blink image, according to an exemplary embodiment of the present system and method. FIG. 13 shows a method for inducing a user's blink by using a blink image, according to another exemplary embodiment of the present system and method. FIG. 14 shows a method for inducing a user's blink by using a blink image, according to the other exemplary embodiment of the present system and method. FIG. 15 shows a method for inducing a user's blink by using a blink image, according to the other exemplary embodiment of the present system and method.

FIG. 12 shows a blink image 33 acquired by photographing the face of the user with his eyes opened. FIG. 13 shows a blink image 33 acquired by photographing the face of the user with his eyes closed. FIG. 14 shows a blink image 33 acquired by photographing the opened eye portion of the user. FIG. 15 shows a blink image 33 acquired by photographing the closed eye portion of the user.

Referring to FIG. 12 to FIG. 15, the blink image 33 is not displayed at the time T0 when the user's blink detection starts. The blink image 33 is displayed at the time Ti1 that is delayed by a delay time (Td) from the time Tb1 when the user's blink is detected. That is, the blink image 33 is not displayed between the time Ti1 and the time T0. The blink image 33 is displayed for a short duration of user's cognition available. The display of the blink image 33 is delayed from the time Tb2 when the user's blink is detected by a delay time (Td), and then the blink image 33 is displayed at Ti1.

The accompanying drawings and the exemplary embodiments of the present system and method are only examples and do not limit the scope of the present system and method. It is understood by those of ordinary skill in the art that various modifications and equivalent embodiments may be made without departing from the scope and spirit of the present system and method.

What is claimed is:

1. A blink device comprising:
a blink detector configured to detect a blink of a user from an image photographed by a camera;
a period measurer configured to:
measure a time period between consecutive blinks of the user and determining, and
determine whether the measured time period exceeds a reference time period;
a real-time image capture unit configured to capture a real-time image of the user from the photographed image; and
an image processor configured to perform the following if the measured time period exceeds the reference time period:
generate from the real-time image a blink image for inducing the user to blink,
delay the display of the blink image by a delay time period from when the user's blink is detected, and
display the blink image after the delaying.

2. The blink device of claim 1, wherein
the image processor is further configured to generate an additional blink image for display in place of the blink image during the delay period.

3. The blink device of claim 2, wherein
the additional blink image is an image of the user's face and generated from a photographed image of the user in which the user's eyes are opened, and the blink image is an image of the user's face and generated from a photographed image of the user in which the user's eyes are closed.

4. The blink device of claim 2, wherein
the additional blink image is an image of the user's eye portions and generated from a photographed image of the user in which the user's eyes are opened, and the blink image is an image of the user's eye portions and generated from a photographed image of the user in which the user's eyes are closed.

5. The blink device of claim 1, wherein
the blink image has transparent properties.

6. The blink device of claim 1, wherein
the blink image is an image of the user's face and generated from a photographed image of the user in which the user's eyes are opened.

7. The blink device of claim 1, wherein
the blink image is an image of the user's face and generated from a photographed image of the user in which the user's his eyes are closed.

8. The blink device of claim 1, wherein
the blink image is an image of the user's eye portions and generated from a photographed image of the user in which the user's eyes are opened.

9. The blink device of claim 1, wherein
the blink image is an image of the user's eye portions and generated from a photographed image of the user in which the user's eyes are closed.

10. The blink device of claim 1, wherein
the delay time period is less than the reference time period.

11. The blink device of claim 1, further comprising
a camera controller configured to control the driving of the camera and provide the photographed image to the blink detector and the real-time image capture unit.

12. A method for inducing a blink comprising:
detecting a blink of a userfrom an image photographed by a camera;
measuring a time period between consecutive blinks of the user;
comparing the measured time period between the user's blinks and a reference time period; and
performing the following if results of the comparing indicate that the measured time period exceeds the reference time period:
delaying the display of a blink image by a delay time period from when the user's blink is detected, and
displaying the blink image after the delaying.

13. The method of claim 12, further comprising:
capturing a real-time image from the photographed image; and
generating the blink image from the real-time image.

14. The method of claim 13, further comprising generating an additional blink image and displaying the additional blink image in place of the blink image during the delay period.

15. The method of claim 14, wherein
the additional blink image is an image of the user's face and generated from a photographed image of the user in which the user's eyes are opened, and the blink image is an image of the user's face and generated from a photographed image of the user in which the user's eyes are closed.

16. The method of claim 14, wherein
the additional blink image is an image of the user's eye portions and generated from a photographed image of the user in which the user's eyes are opened, and the blink image is an image of the user's eye portions and generated from a photographed image of the user in which the user's eyes are closed.

17. The method of claim 13, wherein
the blink image is repeatedly displayed when the user's blink is detected.

18. The method of claim 13, wherein
the blink image includes at least one of an image of the user's face with his eyes opened, an image of the user's face with his eyes closed, an image of the opened eye portions of the user, and an image of the closed eye portions of the user.

19. The method of claim 13, wherein
the delay time period is less than the reference time period.
